(19) United States
(12) Patent Application Publication
(10) Pub. No.: US 2019/0340325 A1
(43) Pub. Date: Nov. 7, 2019

(54) WIRE ROUTING ALGORITHM

(71) Applicant: The Charles Stark Draper Laboratory, Inc., Cambridge, MA (US)

(72) Inventors: Austin Herrling, Cambridge, MA (US); Michael Ricard, Cambridge, MA (US); Juan Pablo Vielma, Cambridge, MA (US); Jason Haley, Cambridge, MA (US); Anthony Kopa, Cambridge, MA (US); David Hagerstrom, Cambridge, MA (US); Caprice Gray Haley, Cambridge, MA (US)

(21) Appl. No.: 16/400,915

(22) Filed: May 1, 2019

Related U.S. Application Data
(60) Provisional application No. 62/665,082, filed on May 1, 2018.

(51) Int. Cl. G06F 17/50

(52) U.S. Cl. CPC G06F 17/5077

(57) ABSTRACT

A method for determining a wire connection plan includes receiving a wiring specification including a set of links and a first set of connection points. Each link specifies a connection between two connection points of the first set of connection points. The method includes determining the wire connection plan including an ordered sequence of wire segments linking points of a second set of connection points, the second set of connection points including the first set of connection points and a set of additional connection points. At least some wire segments in the ordered sequence of wire segments linking two connection points of the first set of connection points, at least some wire segments in the ordered sequence of wire segments forming part of a connection between two points in the first set of connection points through one or more of the connection points in the set of additional connection points, and determining an order for the ordered sequence of wire segments such that each wire segment linking connection points of the second set of connection points does not cause occlusion of any connection point used in a later wire segment in the ordered sequence of wire segments.

### CROSS-REFERENCE TO RELATED APPLICATIONS

This application claims the benefit of U.S. Provisional Application No. 62/665,082 filed May 1, 2018, the contents of which are incorporated herein in their entirety.

### BACKGROUND

Integrated Circuit (IC) technology is ubiquitous in the modern day. Much of this can be attributed to the shrinking scale of ICs; as chip size decreases, it becomes easier to utilize ICs in diverse applications. Even as chip sizes shrink, IC technology increases in power, with more transistors, gates, and sensors being packed on to smaller and smaller chips. These technological advances are facilitated by simultaneous technological development in the manufacture and design of ICs.

The chip design process begins with a circuit description, which details the components and functions of the entire chip. A chip designer converts this circuit description into a geometric description called a layout, which describes the layer and placement of all electronic components. Chip designers check these layouts against design requirements and generate pattern generator files that are then used in the chip fabrication process.

To produce a layout, or the geometric representation of a circuit, chip designers frequently use automated software tools that arrange the necessary components and route wires between them. The software tools observe some additional design rule constraints, which include constraints like preventing bare wires from crossing to avoid electrical interference and matching wire lengths for certain groups of wires, primarily those connected to memory components. For complex chips with a large number of interconnects, the task of arranging components within the chip space is generally performed manually, as the large number of variables and constraints significantly slows down even the best automated software. Additionally, manual layouts tend to perform better than automated layouts, most likely due to the intuitive understanding of chip designers.

One phase in producing the layout is the routing phase. During the routing phase, the locations of components on the chip are used to generate a netlist, which describes the full set of connections that must be made. Routing is usually divided into two phases: global routing and detailed routing. In the global routing phase, loose routes are generated for each net. In the detailed routing phase, these loose routes are transformed into an actual geometric route that the associated wire will take. Wires used in conventional printed circuit board (PCB) designs are unshielded. This property necessitates a PCB design rule to ensure that no wires can cross in close proximity to one another. Because of this, PCB layouts generally need to be multi-layered in order to feasibly route all required wires.

### SUMMARY

Conventional chip design techniques involve multi-layered techniques to prevent wire crossings and electrical interference. As a result, conventional wire routing software is typically only capable of routing a subset of the interconnects and does not provide solutions for wire intersections. Sequencing placements is generally computationally intractable and physical ordering of interconnect placement is often operator-defined.

Some new approaches to circuit fabrication make connections using wires such as coaxial wires rather than embedded traces. In such approaches, wire crossings are no longer a restriction on how PCBs are designed or how wires are routed. This in turn allows engineers to place all PCB components on a flat plane, greatly simplifying both the chip design and the fabrication process. See, for example U.S. Patent Publication No. 2018-0098437, incorporated herein by reference.

Aspects described herein are related to tools and algorithms for determining an optimal component placement and wire routing for circuits that using wire-only connections. Aspects both evaluate build feasibility and deliver a wire placement procedure. The feasibility of a wire routing is defined by the ability to place all interconnect to create a working circuit and includes parameters such as wire width, component geometries, and a head size of a wire bonding tool.

In one aspect, the algorithm generates a conflict graph from a representation of a physical circuit layout. The physical circuit layout includes physical wire routings that are represented as pairs of endpoints connected by a (sometimes straight) line. The conflict graph represents conflicting physical wire routings that are not possible due to, for example, a wire obstructing an endpoint to which another wire is to be attached.

The algorithm identifies conflicting physical wire routings using the conflict graph (where the conflicts are represented as cycles in the graph) and then resolves the conflicts by placing stopover points for conflicting wire routings. In some examples, the placement of stopover points is determined based on a number of constraints generated from the endpoints of the wire routings and blacklisted wire pads.

In some examples a routing order is then determined using, for example, a topological sort of the wire routings, where wire routings that do not cross wire pads are routed first.

In a general aspect, a method for determining a wire connection plan includes receiving a wiring specification including a set of links and a first set of connection points, each link of the set of links specifying a connection between two connection points of the first set of connection points and determining the wire connection plan including an ordered sequence of wire segments linking points of a second set of connection points, the second set of connection points including the first set of connection points and a set of additional connection points. At least some wire segments in the ordered sequence of wire segments linking two connection points of the first set of connection points, at least some wire segments in the ordered sequence of wire segments forming part of a connection between two points in the first set of connection points through one or more of the connection points in the set of additional connection points, and determining an order for the ordered sequence of wire segments such that each wire segment linking connection points of the second set of connection points does not cause occlusion of any connection point used in a later wire segment in the ordered sequence of wire segments.

Aspects may include one or more of the following features.

The method may include forming a conflict graph from the wiring specification and determining the set of additional connection points based at least in part on the conflict graph. Determining the set of additional connection points may include identifying the presence of a cycle in the conflict graph. Identifying the presence of a cycle in the conflict graph may include determining that there is no ordered sequence of wire segments that connects the wire segments to the connection points of the first set of connection points without occluding at least one connection point of the first set of connection point.

Determining the set of additional connection points may include identifying candidate spatial locations for the set of additional connection points. Identifying candidate locations for the set of additional connection points may be based on a mixed-integer program approach. Identifying the candidate locations may include applying spatial constraints to the wiring specification based on one or more of locations and dimensions of connection points, locations and dimensions of electrical components, and locations and dimensions of connected wires.

Determining the order for the ordered sequence of wire segments may include performing a topological sort. The wire segments may include coaxial wires. A first subset of the wire segments may be configured for routing power. The method may include identifying, in the wiring specification, one or more capacitors specified as being connected to wire segments for routing power and modifying the wiring specification to extend a connection region associated with the identified one or more capacitors. A second subset of the wire segments may be configured for carrying signals.

In another general aspect, a system for determining a wire connection plan includes an input for receiving a wiring specification including a set of links and a first set of connection points, each link of the set of links specifying a connection between two connection points of the first set of connection points and one or more processing elements configured to perform the steps of determining the wire connection plan including an ordered sequence of wire segments linking points of a second set of connection points, the second set of connection points including the first set of connection points and a set of additional connection points. At least some wire segments in the ordered sequence of wire segments linking two connection points of the first set of connection points, at least some wire segments in the ordered sequence of wire segments forming part of a connection between two points in the first set of connection points through one or more of the connection points in the set of additional connection points, and determining an order for the ordered sequence of wire segments such that each wire segment linking connection points of the second set of connection points does not cause occlusion of any connection point used in a later wire segment in the ordered sequence of wire segments.

In another general aspect, software embodied on a non-transitory machine-readable medium for determining a wire connection plan includes instructions for causing a computing system to receive a wiring specification including a set of links and a first set of connection points, each link of the set of links specifying a connection between two connection points of the first set of connection points and determine the wire connection plan including an ordered sequence of wire segments linking points of a second set of connection points, the second set of connection points including the first set of connection points and a set of additional connection points. At least some wire segments in the ordered sequence of wire segments linking two connection points of the first set of connection points, at least some wire segments in the ordered sequence of wire segments forming part of a connection between two points in the first set of connection points through one or more of the connection points in the set of additional connection points, and determining an order for the ordered sequence of wire segments such that each wire segment linking connection points of the second set of connection points does not cause occlusion of any connection point used in a later wire segment in the ordered sequence of wire segments.

In another general aspect, a system for determining a wire connection plan includes means for receiving a wiring specification including a set of links and a first set of connection points, each link of the set of links specifying a connection between two connection points of the first set of connection points and means for performing the steps of determining the wire connection plan including an ordered sequence of wire segments linking points of a second set of connection points, the second set of connection points including the first set of connection points and a set of additional connection points. At least some wire segments in the ordered sequence of wire segments linking two connection points of the first set of connection points at least some wire segments in the ordered sequence of wire segments forming part of a connection between two points in the first set of connection points through one or more of the connection points in the set of additional connection points, and determining an order for the ordered sequence of wire segments such that each wire segment linking connection points of the second set of connection points does not cause occlusion of any connection point used in a later wire segment in the ordered sequence of wire segments.

Aspects may have one or more of the following advantages.

In contrast to conventional circuit fabrication systems, aspects described herein leverage the usage of micro-coaxial cables and planar component placement to advantageously avoid several of the lengthy chip design steps. The problem of component arrangement in a layout is significantly simplified by reducing the three-dimensional aspect of placement to just two dimensions.

The usage of micro-coaxial cables advantageously reduces the total number of wires necessary as well as some design rules. Because each wire is individually shielded, wires can be grounded using their shields during the fabrication process, eliminating the need for routing additional grounding wires during the layout and routing phase of chip design. The shielding also removes the constraint of keeping wires from touching or crossing, giving greater degrees of freedom for wire placement on the chip.

Shielded wires maintain electrical integrity of their signals far better than unshielded wires. This can advantageously reduce or even completely remove the electrical verification portion of the design phase. The combination of these improvements, along with concurrent technology being developed to bond and route the micro-coaxial wires, gives the overall design process a timescale of days, instead of the weeks or months traditional routing techniques could require.

Other features and advantages of the invention are apparent from the following description, and from the claims.

### DESCRIPTION OF DRAWINGS

FIG. 1 is a circuit design and fabrication workflow.

FIGS. 2A and 2B show a blacklisted connection pad.

FIGS. 3A and 3B show a capacitor extension region.

FIG. 4 shows a physical wire routing layout.

FIG. 5 shows the layout of FIG. 4 represented as a conflict graph.

FIG. 6 shows stopover point placement constraints.

FIGS. 7 and 8 show feasible stopover placement spaces based on connection endpoints.

FIG. 9 shows feasible stopover placement spaces based on component placement.

FIG. 10 shows a combination of the feasible stopover placement spaces of FIGS. 7-9.

FIG. 11 shows a restricted region around a wire.

FIG. 12 is a stopover generation procedure.

FIG. 13 shows an example of progression of the stopover generation procedure of FIG. 12.

FIG. 14 shows another example of stopover point placement constraints.

### DESCRIPTION

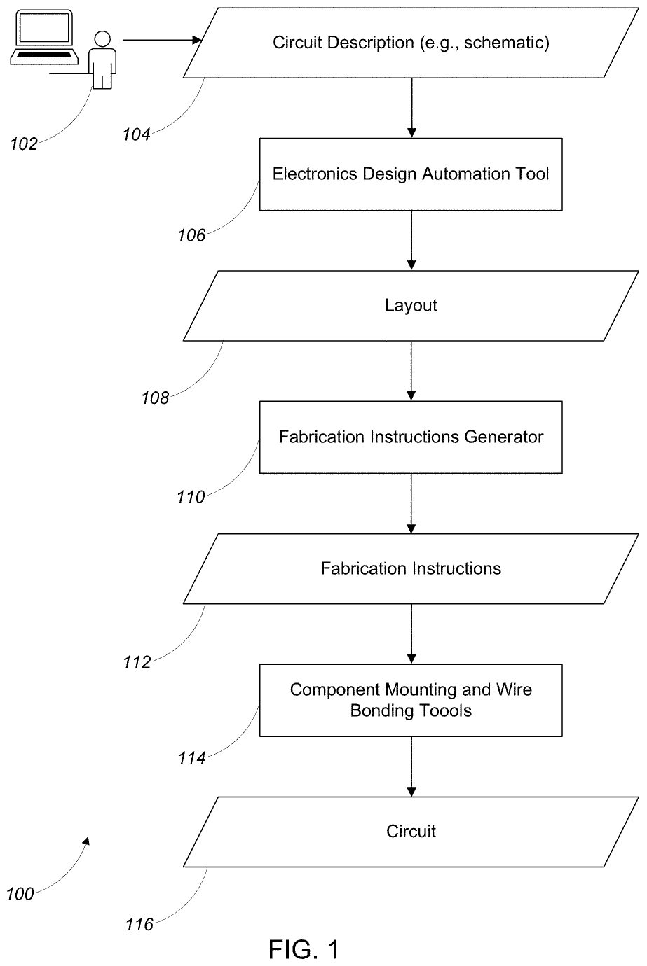

Referring to FIG. 1, a circuit design and fabrication procedure 100 begins when a user 102 specifies a circuit description 104 (e.g., a schematic) for a circuit. The circuit description 104 is provided to an electronics design automation tool 106 that automatically, or with the help of the user 102 generates a physical layout 108 for the circuit. Very generally, the layout 108 specifies a placement of components (e.g., resistors, capacitors, integrated circuits, etc.) on a substrate and a routing of wires (e.g., micro-coaxial wires) that properly connects the placed components while also obeying any design rules specified for the circuit.

The layout 108 is provided to a fabrication instructions generator 110 that processes the layout 108 to generate fabrication instructions 112. Very generally, the fabrication instructions 112 include etching patterns, locations of through holes in the substrate, locations of connection pads, wire bonding instructions, etc.

The fabrication instructions 112 are provided to fabrication tools 114 (e.g., PCB fabrication tools, component mounting tools, and wire bonding tools). The fabrication tools 114 operate according to the fabrication instructions 112 to fabricate a physical circuit 116. One example of a fabrication tool for attaching micro-coaxial wires is described in U.S. patent application Ser. No. 16/201,013, which is incorporated herein by reference.

### 1 Electronics Design Automation Tool

As is noted above, new approaches to circuit fabrication make connections using wires such as coaxial wires rather than embedded traces. In such approaches, wire crossings are no longer a restriction on how PCBs are designed or how wires are routed. This in turn allows engineers to place all PCB components on a flat plane, greatly simplifying both the chip design and the fabrication process. As is described in greater detail below, the electronics design automation tool 106 is configured to determining an optimal component placement and wire routing for circuits that using wire-only connections. Aspects both evaluate build feasibility and deliver a wire placement procedure.

Operation of the electronics design automation tool 106 is based on a number of constraints. One important constraint placed on the electronics design automation tool 106 is that only point-to-point straight line connections between connection pads are allowed, which reflects the behavior of wire bonders that are used in fabrication of the circuit 116.

Another constraint placed on the electronics design automation tool 106 is that wires are not allowed to cross over “blacklisted” connection pads on the circuit board. Very generally, blacklisted connection pads are unbonded wire pads over which routed wires are not allowed to pass. The electronics design and automation tool 106 is configured to identify situations where a wire will cross over blacklisted connection pads and to avoid such situations by placing “stopover” points somewhere on the circuit board. Very generally, stopover points are non-terminal locations on the surface of the circuit board through which wires are routed to avoid crossing over blacklisted wire pads.

The notion of crossing blacklisted pads is geometric, as both wires and wire pads have physical width. Different wire and pad widths may be specified as input to the electronics design automation tool 106, where a wire width of 25 μm and a pad width of 62.5 μm (a ratio of 2.5 between the pad width and the wire width) is commonly used. In some examples, different between types of wires, as power and signal wires with different construction and different widths are specified as input to the electronics design automation tool 106.

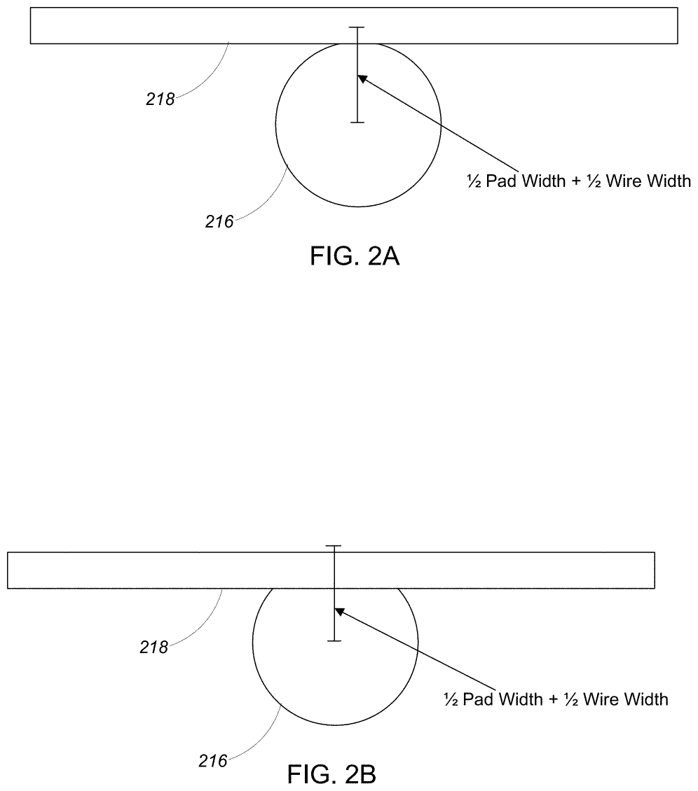

Referring to FIGS. 2A and 2B, a blacklisted pad crossing is defined as case where the distance between the center of a wire and the center of a blacklisted pad is less than half the width of the blacklisted pad plus half the width of the wire. In FIG. 2A, a distance between a center of a blacklisted pad 216 and a center of a wire 218 is greater than half the width of the blacklisted pad plus half the width of the wire, so the wire does not cross the blacklisted pad. In FIG. 2B, a distance between a center of a blacklisted pad 216 and a center of a wire 218 is less than half the width of the blacklisted pad plus half the width of the wire, so the wire crosses the blacklisted pad.

Finally, the electronics design automation tool 106 solves for a feasible routing order that, when implemented by an automated wire bonder or a technician, is a numbered list that describes the order in which wires must be routed. The information for each wire includes its endpoints, its associated net name, and the physical locations of any necessary stopover points along the wire. In some examples, the routing order also minimizes total wire length, which saves money and manufacturing time.

### 1.1 Wire Routing Algorithm

In some examples, the electronics design automation tool 106 uses extended capacitor regions, additional stopover point constraints, and a mixed integer programming approach to determine the wire routing order. This approach works for multiple types of wires (e.g., both signal wires and power wires), and nets of any size.

Very generally, and as is described below, the wire routing algorithm routes both power wires and signal wires. In some examples, to route power wires, capacitor extension regions are formed for capacitors disposed on the circuit board. Then conflict graph is formed to determine a routing order and to identify situations where stopover points need to be added to make the routing feasible. Finally, a stopover point placement procedure is the performed to determine where stopover points can be added to the circuit board.

### 1.1.1 Power Routing Using Extended Capacitor Regions

In some examples, wire-only routing introduces many connections of power wires to capacitor locations on the circuit board. It is possible that the number of required connections of power wires to a particular capacitor pin exceeds a maximum physical connection limit (i.e., there is no more space for wires to be connected). The electronics design automation tool 106 addresses this problem as described below.

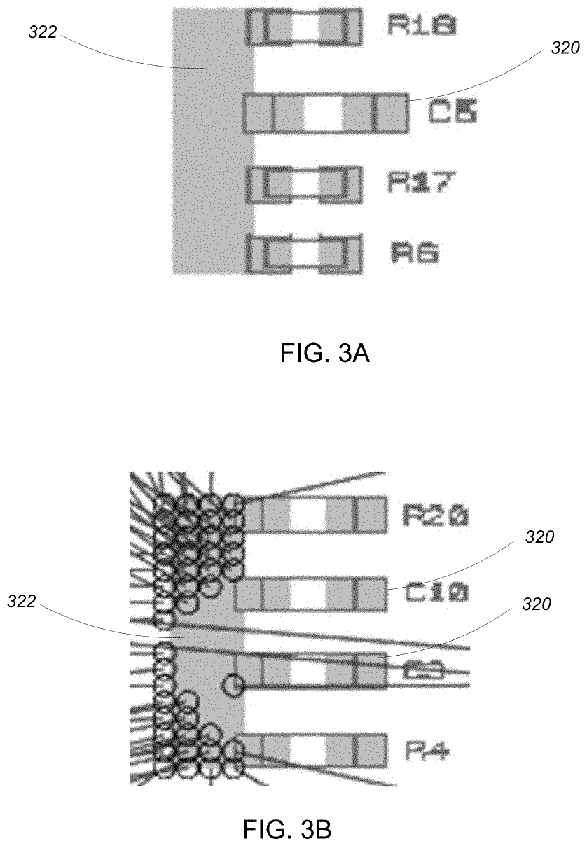

To route power wires, a list of capacitor locations on the board is provided to the electronics design automation tool 106. Referring to FIG. 3A, for at least some of the capacitors 320 specified in the list, an expanded region 322 is placed on the chip that that functions as an extension to the capacitors 320. The components labeled R18, R17, and R6 are all resistors, and the component labeled C6 is a capacitor. The rectangular area to the left of the capacitor is the expanded electrical connection region 322 placed on the chip.

In some examples, without the expanded regions 322, it is not possible to route all power wires to capacitors without multiple wires connecting to a single point (which may not be feasible given a large number of power wires). Referring to FIG. 3B, the expanded regions 322 allow for placement of additional capacitor pins. In FIG. 3B, a number of power wires are connected to the additional capacitor pins in the expanded region 322.

### 1.1.1.1 Power Node Assignment

In some examples, given spatial coordinates of the expanded regions 322 on the circuit board, power nodes (i.e., wire terminations to power) are assigned to the regions 322 using a greedy algorithm that breaks the assignment problem into two sub-problems.

The first sub-problem is placing pin endpoints on the given capacitor region 322. The region is a continuous block of metal, so pin placement is unrestricted; as long as a minimum distance between the centers of any two pads is maintained. This distance ensures that the wire bonder head can reach the PCB without being blocked by a wire.

Pins are placed on the capacitor region by creating rectangles side which the power endpoints are placed. These rectangles are created by first dividing the region into squares with side length equal to the minimum distance between pad centers; ensuring a feasible solution, with space for each power endpoint to be created. This process creates a large number of excess squares, as the capacitor regions are quite large by design. Once all of the squares are generated, the side lengths of the squares are iteratively increased. This simultaneously decreases the number of squares that can fit in the region, so the side lengths are increased until any further increases would result in too few squares in the region. Because the regions are not square in general, the squares are extended into rectangles along the long axis of the region.

With all of the squares/rectangles created, the center points of the squares/rectangles are used as power endpoints. Thus, begins the second sub-problem, the assignment phase. This problem is solved greedily by iterating through the power nets and assigning the closest endpoin in the appropriate region.

### 1.1.2 Routing Order

In some examples, a routing order for the wires is determined, at least in part using a “conflict” graph data structure representative of the physical layout of the chip and pins.

### 1.1.2.1 Conflict Graph

In order to globally minimize the number of routes to which stopover points needed to be added, a “conflict” graph data structure for keeping track of blacklisted pad crossings at every stage of the algorithm is maintained. To build the conflict graph, a wire layout is analyzed and every pair of connection points in the wire layout is represented as a single node in the graph. Next, a straight line rotationally routed between every pair's endpoints. If the straight line crosses over any other wire pads, an edge is added to the graph, directed from the crossed pair to the pair that crossed it. The interpretation of this edge is natural; if a pair is crossed by a wire for some other pair, the crossed pair needs to be routed first. Thus, there is an edge directed from the crossed pair to the crossing pair.

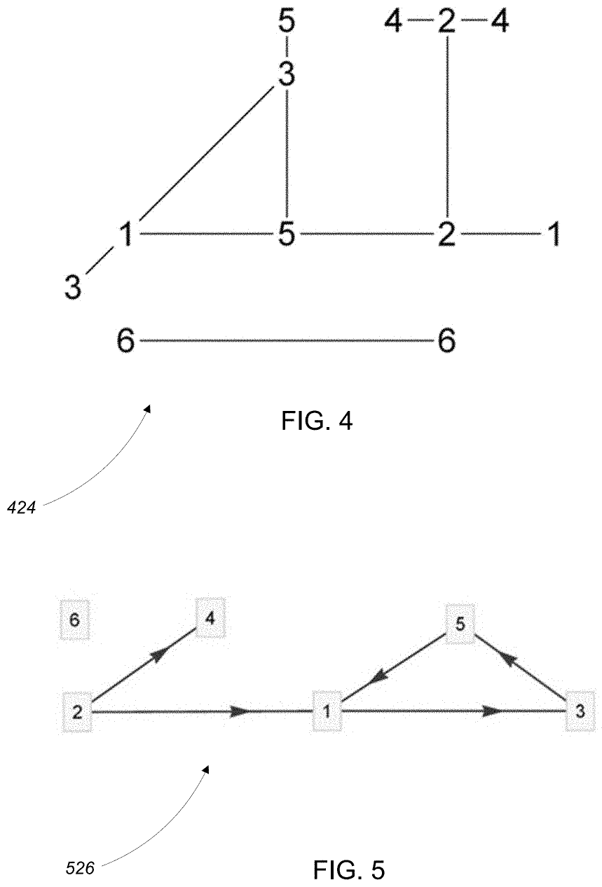

Referring to FIG. 4, a layout of wires 424 shows a wire with endpoints labeled ‘4’ crossing an endpoint of a wire labeled ‘2.’ Similarly, a wire with endpoints labeled ‘3’ crosses an endpoint of a wire labeled ‘1,’ a wire with endpoints labeled ‘5’ crosses an endpoint of a wire labeled ‘3,’ and the wire with endpoints labeled ‘1’ crosses endpoints of the wires labeled ‘5’ and ‘2.’

Referring to FIG. 5, the conflict graph is initialized by creating a node for each pair of endpoints; wire 1 is represented by node 1, wire 2 by node 2, etc. Next, if any wire in the physical layout crosses an endpoint of another wire, an edge directed from the crossed pair to the crossing pair is added to the conflict graph 526. Thus, because wire 4 crosses an endpoint of wire 2, an edge from 2 to 4 is added. Once edges are added for every such crossing, the conflict graph 526 is complete.

Conflict graphs are not, in general, acyclic. In fact, if a conflict graph had no cycles, a topological sort could be performed to immediately retrieve a valid routing order, without having to place any stopover points. If a graph does have cycles, stopover points are required. This is because adding stopover points changes edges. For example, in FIG. 5, a cycle exists between pairs 1, 3, and 5. If a point on the graph were added such that wire 1 no longer crossed over an endpoint of wire 5, the edge between 1 and 5 could be removed, and the wires could be routed in the order 1→3→5, without any wire crossing a wire pad that has not yet been bonded (a blacklisted wire pad).

The structure of the conflict graph is used to determine the routing order. First, all zero-crossing wires are routed. Next, when no zero-crossing wires remain, wires with minimal crossings are routed. This can be characterized as routing all pairs with zero indegree in the conflict graph and then routing pairs that have minimal indegree when no more pairs with zero indegree remain.

In some examples, to minimize stopover points, a modified strategy routes pairs with maximum outdegree once all nodes with zero indegree were routed. Because adding stopover points deletes edges directed to the pair with the stopover point, routing pairs with maximum outdegree maximizes the number of nodes from which a potential conflict is deleted. In some examples, this modified strategy decreases the necessary number of stopover points by an order of magnitude.

### 1.1.3 Stopover Point Placement and Optimization

In some examples, in addition to the wires being constrained to not cross over blacklisted connection pads, any stopover points are constrained such that they are prevented from being placed on any chip component or within on the circuit board or within a short distance of existing stopover points.

In order to minimize the number of stopover points while accounting for constraints on stopoverpoint placement, a mixed-integer program (MIP) formulation is used to choose locations for stopover points. The usage of a MIP accounts for the above-described constraints while still guaranteeing the minimum possible wire length for each necessary stopover point.

### 1.1.3.1 Blacklisted Cones

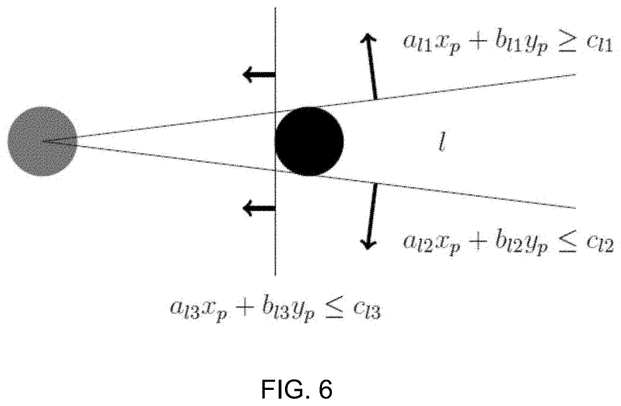

Preprocessing is required before using the MIP to choose locations for stopover points. The preprocessing involves the construction of specific constraints for each blacklisted point. Referring to FIG. 6, the start point and end point of each pair induce three constraints each. In the figure, the pair endpoint is shown as the circle on the left, and the blacklisted point is shown as the circle on the right. Constraints cₗ₁ and cₗ₂ are defined by the pair endpoint and lines tangent to the blacklisted point, and constraint cₗ₃ is defined by a line tangent to the blacklisted point and perpendicular to the vector from the pair endpoint to the blacklisted point.

The purpose of these constraints is to describe all feasible regions that a stopover point could be placed. If a stopover point is placed such that it does not satisfy at least one of these constraints, then a wire to that stopover point must cross over the wire pad around the blacklisted point. The constraints, when combined, define the outline of what is called a blacklisted cone, which is indicated in the figure with l. Because each blacklisted point requires a cone, for both the start and end points of a pair, many blacklisted points results in a large formulation. Fortunately, as more stopover points are placed, the problem will shrink; as the number of blacklisted points remaining shrinks, so too does the size of the formulation. This also generally results in an increase in the feasible space in which stopover points can be placed, potentially resulting in shorter wires and more optimal placement.

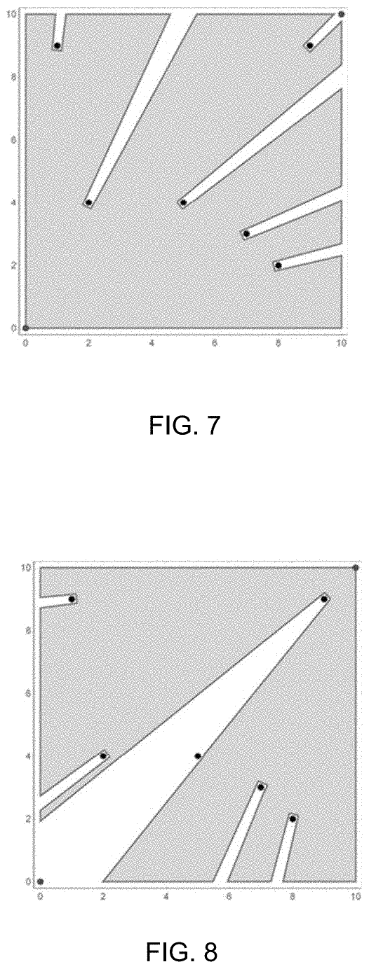

Referring to FIGs. 7 and 8, feasible regions created by blacklisted cones are demonstrated using an example pair to be routed, blacklisted points, and some chip components. In FIG. 7 the start point is shown in the bottom left corner, and a number of blacklisted points are distributed throughout the region. The blacklisted cones are in white, and so the feasible locations for stopover points are shown as shaded areas. These constraints exist for both the start and end point (see FIG. 8 for the endpoint example), and the size of these cones change based on their distance from either point.

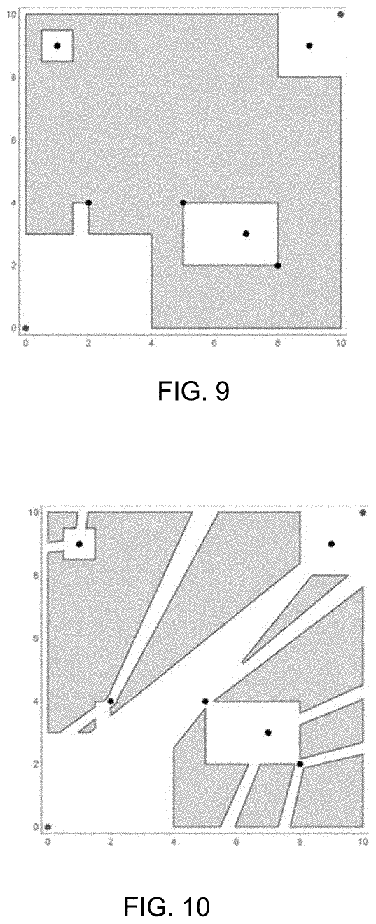

Referring to FIG. 9, some example component locations are shown, with the white regions representing areas stopover points cannot be placed. Referring to FIG. 10, a union of all of the constraints from FIGS. 7-9 shows how the feasible space where stopover points can be placed shrinks significantly even with a small number of blacklisted points and components.

### 1.1.3.2 Optimized Placement for a Single Stopover Point

Determining the optimized placement of stopover points begins with the coordinates of the start points (xₛ, yₛ) and the coordinates of the end points (xₑ, yₑ) for all wire connections. For all calculations involving wire width and pad widths, the type of wire and type of pad involved are considered. For blacklisted cones, the radius of the blacklisted pad used in generating the constraints is half the width of the blacklisted pad plus half the width of the wire used. Because the pair endpoints, the location of all blacklisted points, the width of the blacklisted pad, and the width of the wire to be routed between the pair endpoints are all known, every blacklisted cone constraint can be generated prior to solving the MIP. These constraints are the bulk of the inputs to the MIP. The set of blacklisted cone constraints is referred to as L, with individual cones referred to by l.

All additional constraints outlining where stopover points can legally be placed are also needed. Apart from blacklisted cones, stopover points cannot be placed on top of previously placed wires, or on top of existing chip components. As in the case of the blacklisted cones, these two sets of constraints are made up entirely of known data.

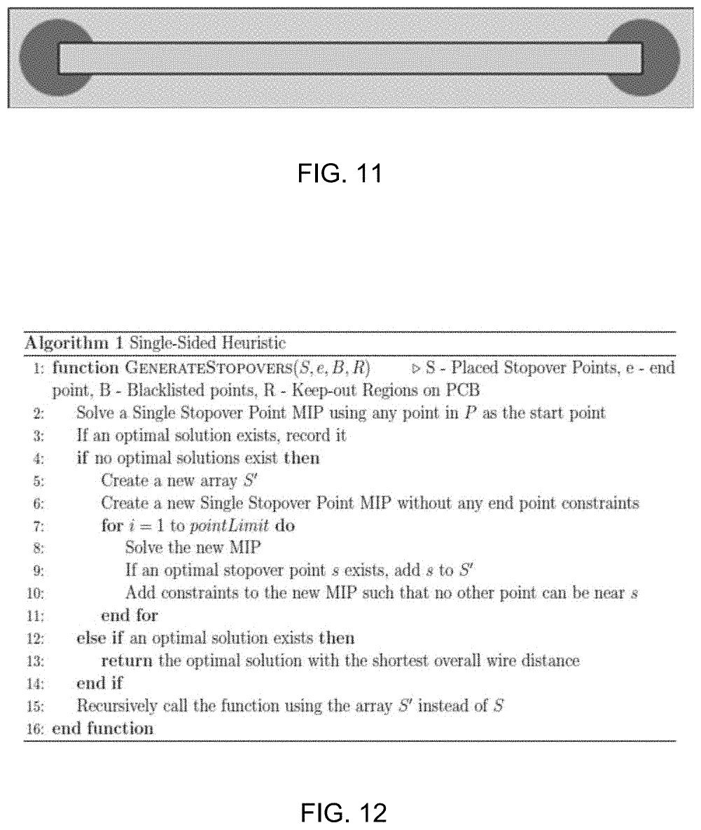

Referring to FIG. 11, to avoid placing stopover points on existing wires, the list of placed wires is iterated through, creating regions for each pair. In FIG. 11, the pair endpoints are represented as circles, the placed wire is represented as a rectangle extending between the circles, and the restricted region is represented as a shaded rectangle surrounding the pair endpoints and the placed wire. Regions are created by drawing a rectangle that completely encompasses the wire and its endpoints, with distance from the wire equal to the width of a wire pad. Because the pair endpoints are necessarily located on chip components, a primary concern is ensuring that the stopover point is not placed on top of an existing wire, which the size of the rectangle guarantees. In the case of previously placed wires with multiple connection points, the wire is broken down into its individual pairs, and a new region is created for each pair, Each restricted wire region is represented as a w in the set W.

Constraints relating to PCB components are simple the upper and lower x and y coordinates of each component are provided, and the components are aligned on the PCB without any rotation. Each set of component constraints is referred to as an r in the set R.

Finally, the x and y coordinates for the limit of the PCB surface are needed in order to restrict the values that the decision variables (described below) can take. These limits are referred to as maxₓ, max_{y}, minₓ, and min_{y} for the maximum x and y and the minimum x and y values, respectively.

### 1.1.3.3 Decision Variables

The primary decision variables for the MIP are xₚ and yₚ, the x and y coordinates of the stopover point to be placed. A large number of binary decision variables are also used in the convex formulation of the stopover point placement problem described below.

### 1.1.3.4 Nonconvex Formulation

There are a large number of constraints of the type (xₚ,y_{P}∉R for some region R). This includes blacklisted cones l∈L, all PCB components r∈R, and all previously placed wires w∈W. The problem can be formulated in the following way:

min(xₛ−xₚ)²+(yₛ−yₚ)²+(xₑ−xₚ)²+(yₑ−yₚ)²

(xₚ,yₚ)∉l∀l∈L

(xₚ,yₚ)∉r∀r∈R

(xₚ,yₚ)∉w∀w∈W

minₓ≤xₚ≤maxₓ

min_{y}≤yₚ≤max_{y}

### 1.1.3.5 Convex Formulation

To create a convex formulation, sets of binary variables that control which constraint is active per region are formed.

For example, in FIG. 6, the constraints aₗ₁, aₗ₂, and aₗ₃ are described. Three binary variables z₁, z₂, and z₃ are then defined to restrict constraint aᵢ to being active when variable zᵢ is equal to 1, and inactive when zᵢ is equal to 0. In some examples, this is accomplished by using a Big-M formulation. The Big-M formulation was chosen because it is the simplest to describe and understand. The Big-M formulation takes the following form:

aₗ₁xₚ+bₗ₁yₚ−cₗ₁≤(1−z₁)M

aₗ₂xₚ+bₗ₂yₚ−cₗ₂≤(1−z₂)M

aₗ₃xₚ+bₗ₃yₚ−cₗ₃≤(1−z₃)M

z₁+z₂+z₃≥1

The value of M is chosen to activate or deactivate constraints depending on the value of the binary variable. Due to the bounded nature of the PCB (the maximum and minimum x and y values are known for any stopover point), the minimum necessary value of M for each constraint can be recovered.

For each blacklisted cone l∈L, the binary variables zₗᵢ are used. Because there are only 3 constraints per cone, i ranges from 1 to 3. There are 4 constraints per restricted wire region w∈W and per component r∈R, so the variables z_{wj} and zᵣₖ are used for these two sets of constraints, with j and k ranging from 1 to 4. The constraints are all linear, so the coefficients a, b, and c are used as in the standard form of a line ax+by=c, indexed by the number of the constraint and the region to which it corresponds (cones, wire regions, and components). The convex formulation is expressed as follows:

min(xₛ−sₚ)²+(yₛ−yₚ)²+(xₑ−xₚ)²+(yₑ−yₚ)²

s.t. aₗ₁xₚ+bₗ₁yₚ−cₗ₁≤(1−zₗ₁)M

aₗ₂xₚ+bₗ₂yₚ−cₗ₃≤(1−zₗ₂)M∀l∈L

aₗ₃xₚ+bₗ₂yₚ−cₗ₃≤(1−zₗ₃)M

zₗ₁+zₗ₂+zₗ₃≥1

a_{w1}xₚ+b₂₁yₚ−c_{w1}≤(1−z_{w1})M

a_{w2}xₚ+b_{w2}yₚ−c_{w2}≤(1−z_{w2})M

a_{w3}xₚ+b_{w3}yₚ−c_{w3}≤(1−z_{w3})M∀w∈W

a_{w4}xₚ+b_{w4}yₚ−c_{w4}≤(1−z_{w4})M

z_{w1}+z_{w2}+z_{w3}+z_{w4}≥1

aᵣ₁xₚ+bᵣ₁yₚ−cᵣ₁≤(1−zᵣ₁)M

aᵣ₂xₚ+bᵣ₂yₚ−cᵣ₂≤(1−zᵣ₂)M

aᵣ₃xₚ+bᵣ₃yₚ−cᵣ₃≤(1−zᵣ₃)M∀r∈R

aᵣ₄xₚ+bᵣ₄yₚ−cᵣ₄≤(1−zᵣ₄)M

zᵣ₁+zᵣ₂+zᵣ₃+z_{w4}≥1

minₓ≤xₚ≤maxₓ

min_{y}≤yₚ≤max_{y}

zₗᵢ,z_{wj},zᵣₖ∈{0,1}∀l∈L,w∈W,r∈R,i∈{1,3},j,k∈{1,4}

### 1.1.4 Optimized Placement for Multiple Stopover Points

The solution to the stopover placement MIP in the previous section is an optimal placement for a single stopover point on a routed wire. In practice, there is no guarantee that a single stopover point is sufficient for a routing solution; the placement of blacklisted points around one of the pads to be routed could require multiple stopover points. If the MIP is infeasible, there is no way of routing the wire. Currently, if an MIP is determined to be infeasible, the routing order is iterated through to identify alternate pairs to try. When a routing order is determined, the remaining pairs are sorted by outdegree, choosing the pair with the highest outdegree to route first; the next pair in the sorted list is chosen, and the placement problem is resolved with the new pair. In practice, this method handles most situations where some pairs cannot be routed with a single stopover point. In the following sections, two approaches are described that can handle more complicated cases, where no pairs in the routing order can be successfully routed. The first approach is a heuristic that extends the single stopover point placement formulation. This algorithm is employed for more difficult problems. The second approach is a mixed-integer nonlinear program that selects the optimal placement for multiple stopover points, using as few as possible stopover points.

### 1.1.4.1 Single-Sided Heuristic

The heuristic strategy for placing multiple stopover points relies on the formulation set forth in the previous section. When a single stopover point, constraints implied by both the endpoints of the pair to be routed are depended upon. By only considering those constraints corresponding to the starting point, a significant number of constraints that restrict the feasible space in which a stopover point can be placed are removed. Of course, the stopover point placed by such a formulation cannot feasibly connect the two endpoints, but the full MIP can be reformulated and resolved with the stopover point as the new starting point. If this algorithm is iterated to generate a sufficient number of stopover points at each iteration, a feasible route for a wire between the pair endpoints is likely to be found. Referring to FIG. 12, a single-sided heuristic algorithm is shown.

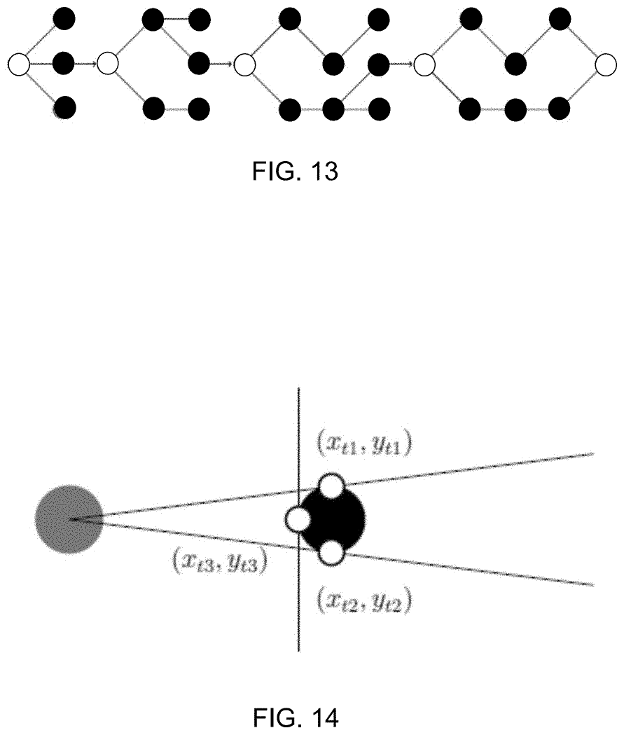

Note that in order to accomplish step 2 of the algorithm, the formulation of the MIP is changed. The first portion of the formulation to change is the objective function. This formulation is being used to choose one of several different starting points. The only time there is more than one starting point occurs when iterating through the algorithm, and the set of starting points is a set of potential stopover points on the original route. Because the starting points are all unique stopover points, each starting point has a different initial distance from the original start point of the pair. If in the first iteration of the algorithm, that distance is just the distance from the original start point to the stopover; if in later iterations, the distance is the sum of the distances between points along the route. This concept of cumulative distance is shown in FIG. 13.

The objective function needs to thus reflect the distance from the chosen start point, to the stopover point, to the end point, plus whatever cumulative distance is attached to the start point. This cumulative distance is known before the problem is solve, and is referred to as DPₛ, the total path distance from the original start to point s. To record the distance from the chosen start point to the stopover point, an additional variable daₛ is defined, which is equal to the squared distance from point s to the stopover point p if points s is selected, and zero otherwise. The new objective function is shown below, along with the constraints associated with the new variables.

$${min ( {x}_{e} - {x}_{p} )}^{2} + {( {y}_{e} - {y}_{p} )}^{2} + {\sum }_{s ∈ S} {DP}_{s} {z}_{s} + {da}_{s}$$

$$s . t . {( {x}_{s} - {x}_{p} )}^{2} + {( {y}_{s} - {y}_{p} )}^{2} \leq {da}_{s} + ( 1 - {z}_{s} ) M {∀}_{s} ∈ S$$

$${da}_{s} \geq 0$$

Each potential starting point has its own unique set of blacklisted cone constraints, so the binary decision variables that control the blacklisted cone constraints are modified. To do this, an additional set of variables zₛ is added, which are equal to 1 if start point s is active, and 0 otherwise. An index s is also added to all coefficients and variables related to blacklisted cones, as the cones are different for each potential starting point S. Finally, the sum of the variables z is restricted to be 1, so that exactly 1 starting point is chosen:

$${a}_{ls 1} {x}_{p} + {b}_{ls 1} {y}_{p} - {c}_{ls 1} \leq ( 2 - {z}_{s} - {z}_{ls 1} ) M$$

$${a}_{ls 2} {x}_{p} + {b}_{ls 2} {y}_{p} - {c}_{ls 2} \leq ( 2 - {z}_{s} - {z}_{ls 2} ) M ∀ l ∈ L , s ∈ S$$

$${a}_{ls 3} {x}_{p} + {b}_{ls 3} {y}_{p} - {c}_{ls 3} \leq ( 2 - {z}_{s} - {z}_{ls 3} ) M$$

$${z}_{ls 1} + {z}_{ls 2} + {z}_{ls 3} \geq 1$$

$${\sum }_{s ∈ S} {z}_{s} = 1$$

And thus the reformulation for multiple starting points is:

$${min ( {x}_{e} - {x}_{p} )}^{2} + {( {y}_{e} - {y}_{p} )}^{2} + {\sum }_{s ∈ S} {DP}_{s} {z}_{s} + {da}_{s}$$

$$s . t . {a}_{ls 1} {x}_{p} + {b}_{ls 1} {y}_{p} - {c}_{ls 1} \leq ( 2 - {z}_{s} - {z}_{ls 1} ) M$$

$${a}_{ls 2} {x}_{p} + {b}_{ls 2} {y}_{p} - {c}_{ls 2} \leq ( 2 - {z}_{s} - {z}_{ls 2} ) M ∀ l ∈ S$$

$${a}_{ls 3} {x}_{p} + {b}_{ls 3} {y}_{p} - {c}_{ls 3} \leq ( 2 - {z}_{s} - {z}_{ls 3} ) M$$

$${z}_{ls 1} + {z}_{ls 2} + {z}_{ls 3} \geq 1 \\ {\sum }_{s ∈ S} {z}_{s} = 1 \\ {a}_{w 1} {x}_{p} + {b}_{w 1} {y}_{p} - {c}_{w 1} \leq ( 1 - {z}_{w 1} ) M \\ {a}_{w 2} {x}_{p} + {b}_{w 2} {y}_{p} - {c}_{w 2} \leq ( 1 - {z}_{w 2} ) M \\ {a}_{w 3} {x}_{p} + {b}_{w 3} {y}_{p} - {c}_{w 3} \leq ( 1 - {z}_{w 3} ) M {∀}_{w} ∈ W$$

$${a}_{w 4} {x}_{p} + {b}_{w 4} {y}_{p} - {c}_{w 4} \leq ( 1 - {z}_{w 4} ) M \\ {z}_{w 1} + {z}_{w 2} + {z}_{w 3} + {z}_{w 4} \geq 1 \\ {a}_{r 1} {x}_{p} + {b}_{r 1} {y}_{p} - {c}_{r 1} \leq ( 1 - {z}_{r 1} ) M \\ {a}_{r 2} {x}_{p} + {b}_{r 2} {y}_{p} - {c}_{r 2} \leq ( 1 - {z}_{r 2} ) M \\ {a}_{r 3} {x}_{p} + {b}_{r 3} {y}_{p} - {c}_{r 3} \leq ( 1 - {z}_{r 3} ) M ∀ r ∈ R \\ {a}_{r 4} {x}_{p} + {b}_{r 4} {y}_{p} - {c}_{r 4} \leq ( 1 - {z}_{r 4} ) M \\ {z}_{r 1} + {z}_{r 2} + {z}_{r 3} + {z}_{r 4} \geq 1 \\ {( {x}_{s} - {x}_{p} )}^{2} + {( {y}_{s} - {y}_{p} )}^{2} \leq {da}_{s} + ( 1 - {z}_{s} ) M ∀ s ∈ S \\ {min}_{x} \leq {x}_{p} \leq {max}_{x} \\ {min}_{y} \leq {y}_{p} \leq {max}_{y} \\ {da}_{s} \geq 0 \\ {z}_{li} , {z}_{wj} , {z}_{rk} , {z}_{s} ∈ \{ 0 , 1 \}$$

$$∀ l ∈ L , w ∈ W , r ∈ R , s ∈ Si ∈ \{ 1 …3 \} , \\ j , k ∈ \{ 1 …4 \}$$

An optimal solution to this MIP will give a stopover point location as well as the starting point used to find the stopover point. This is what is recorded in step 3 of Algorithm 1. If no optimal solution exists, then there is no way to place a single stopover point from any of the starting points to the end point. At this point, a new set of starting points S′ is created, and a new single stopover point placement MW is created. To do this, the same MIP from the previous step is taken and all constraints relating to blacklisted cones induced by the end point of the pair are removed. In effect, this means that only the constraints from FIGS. 7 and 9 are considered, while the constraints from FIG. 8 are ignored. This significantly reduces the total number of constraints in the MIP, while increasing the possible feasible space for additional stopover points. This new MIP is referred to as the One-Sided Single Stopover Point Placement formulation.

The value pointLimit on line 7 of FIG. 12 controls how many new starting points are generated. The algorithm attempts to iterate pointLimit times, continually solving the new one-sided MIP. If, at any point, there is no optimal solution, the algorithm terminates and returns the list of points have been generated so far. If no points have been generated, the entire solution is infeasible, and the algorithm iterates to the next pair in the routing order.

If there is an optimal solution, the algorithm records the new potential starting point s, and adds a set of constraints to the new one-sided MIP, This set of constraints is a bounding box around the new potential starting point and ensures that the next time the MIP is solved, a unique new starting point is generated. This progression of the algorithm is represented in FIG. 13.

In the figure, new rounds of black stopover points are added to the white start point. These stopover points are used to generate more stopover points as the algorithm proceeds. If a stopover point does not generate any new stopover points, it is discarded, so that only feasible routes remain at the end. When the algorithm reaches the white end point, whichever route is the shortest is selected, which is the bottom route in this case. Parameter selection is important for the algorithm. A larger box will result in starting points that are spaced further apart, more drastically changing the feasible stopover point space for each starting point but may also result in fewer points being generated as the feasible space in the current problem decreases. As pointLimit increases, so too does the amount of starting points in every call of the algorithm. This in turn makes finding a multiple stopover point solution more likely. This also increases the complexity of the multiple starting point MIP and the number of one-sided MIPs that need to be solved.

In some practical examples, pointLimit is set to equal to 1. This means a maximum of one new stopover point is generated per round, and this approach usually successfully routes the circuit.

### 1.1.4.2 Multiple Stopover Point Placement Formulation

In another formulation, an MINLP places multiple stopover points along a route. A maximum number of stopover points per route is set to n and the formulation in this section is based on the value of n. The constraints for the multiple stopover point placement problem are no longer linear. Recall in FIG. 6 the construction of the three constraint outlining blacklisted regions. All three of the constraints lie tangent to the blacklisted wire pad, and one of the three lies perpendicular to the line between the start point and the stopover point.

A formulation that allows multiple stopover points to be placed must have blacklisted cone constraints for every pair of points along the route, but these constraints can't be preprocessed if they depend on variable stopover points instead of a defined start and end point. Consider the white tangent points in FIG. 14. The stopover point is represented as the circle on the left and the blacklisted point is represented as the circle on the right. The tangent points are defined as functions of the stopover point p, the blacklisted point b, and the width of the blacklisted pad r, as shown in the expressions below:

$${x}_{{t}_{( 1 , 2 )}} ( p , b , r ) = - {y}_{b} - \frac{\begin{matrix}{r}^{2} ( {y}_{p} - {y}_{b} ) \pm r ( {x}_{p} - {x}_{b} ) \\ \sqrt{- {r}^{2} + {( {x}_{p} - {x}_{b} )}^{2} + {( {y}_{p} - {y}_{b} )}^{2}}\end{matrix}}{{( {x}_{p} - {x}_{b} )}^{2} + {( {y}_{p} - {y}_{b} )}^{2}}$$

$${y}_{{t}_{( 1 , 2 )}} ( p , b , r ) = {x}_{b} + \frac{\begin{matrix}{r}^{2} ( {x}_{p} - {x}_{b} ) \pm r ( {y}_{p} - {y}_{b} ) \\ \sqrt{- {r}^{2} + {( {x}_{p} - {x}_{b} )}^{2} + {( {y}_{p} - {y}_{b} )}^{2}}\end{matrix}}{{( {x}_{p} - {x}_{b} )}^{2} + {( {y}_{p} - {y}_{b} )}^{2}}$$

$${x}_{{t}_{3}} ( p , b , r ) = {x}_{b} - \frac{r ( {x}_{b} - {x}_{p} ) \sqrt{{( {x}_{p} - {x}_{b} )}^{2} + {( {y}_{p} - {y}_{b} )}^{2}}}{{( {x}_{p} - {x}_{h} )}^{2} + {( {y}_{p} - {y}_{b} )}^{2}}$$

$${y}_{{t}_{3}} ( p , b , r ) = {y}_{b} - \frac{r ( {y}_{b} - {y}_{p} ) \sqrt{{( {x}_{p} - {x}_{b} )}^{2} + {( {y}_{p} - {y}_{b} )}^{2}}}{{( {x}_{p} - {x}_{b} )}^{2} + {( {y}_{p} - {y}_{b} )}^{2}}$$

The tangent points are defined as functions of (xₚ, yₚ). To find the constraints associated with each tangent point, the point-slope formula is applied. For points (xₜ₁, yₜ₁) and (xₜ₂, yₜ₂), the slope from the stopover point (xₚ, yₚ) is computed. For point (xₜ₃, yₜ₃), the negative reciprocal of the slope between (xₚ, yₚ) and (x_{b}, y_{b}) is used. For constraints 1 and 2, the slope is

$$\frac{{y}_{{t}_{i}} - {y}_{p}}{{x}_{{t}_{i}} - {x}_{p}} ,$$

Using point-slope form for a line, the expression is

$$y - {y}_{p} = \frac{{y}_{{t}_{i}} - {y}_{p}}{{x}_{{t}_{i}} - {x}_{p}} ( x - {x}_{p} ) .$$

In the standard form of a line, this is

(yₚ+yₜᵢ)x+(−xₚ+xₜᵢ)y=−xₚyₜᵢ+xₜᵢyₚ.

In the formulation, the x and y without subscripts will be replaced with both the next and previous points on the route, for the blacklisted cones in each direction. For constraint 3, the slope is

$$- \frac{{x}_{b} - {x}_{p}}{{y}_{b} - {y}_{p}} ,$$

In point-slope form, this becomes

$$y - {y}_{{t}_{3}} = \frac{{x}_{b} - {x}_{p}}{{y}_{b} - {y}_{p}} ( x - {x}_{{t}_{3}} ) ,$$

which, in standard form, is

(x_{b}−xₚ)x+(y_{b}−yₚ)y=xₜ₃(x_{b}−xₚ)−yₜ₃(yₚ−y_{b}).

All three constraints are now in the form ax+by=c. This is substituted in the equations for xₜᵢ and yₜᵢ, so that there are equations for a, h, and e, which are used in the full formulation. For constraints 1 and 2, a simplified version of their coefficients is first shown, followed by their expansions. Note that each coefficient expands into two different coefficients; this is due to expanding ± and ∓.

$$a ( p , b , r ) = {y}_{p} - {y}_{{t}_{i}}$$

$$b ( p , b , r ) = - {x}_{p} + {x}_{{t}_{i}}$$

$$c ( p , b , r ) = - {x}_{p} {y}_{{t}_{i}} + {x}_{{t}_{i}} {y}_{p}$$

$${a}_{1} ( p , b , r ) = {y}_{p} - {x}_{b} - \frac{\begin{matrix}{r}^{2} ( {x}_{p} - {x}_{b} ) - r ( {y}_{p} - {y}_{b} ) \\ \sqrt{- {r}^{2} + {( {x}_{p} - {x}_{b} )}^{2} + {( {y}_{p} - {y}_{b} )}^{2}}\end{matrix}}{{( {x}_{p} - {x}_{b} )}^{2} + {( {y}_{p} - {y}_{b} )}^{2}}$$

$${a}_{2} ( p , b , r ) = {y}_{p} - {x}_{b} - \frac{\begin{matrix}{r}^{2} ( {x}_{p} - {x}_{b} ) - r ( {y}_{p} - {y}_{b} ) \\ \sqrt{- {r}^{2} + {( {x}_{p} - {x}_{b} )}^{2} + {( {y}_{p} - {y}_{b} )}^{2}}\end{matrix}}{{( {x}_{p} - {x}_{b} )}^{2} + {( {y}_{p} - {y}_{b} )}^{2}}$$

$${b}_{1} ( p , b , r ) = - {x}_{p} - {y}_{b} - \frac{\begin{matrix}{r}^{2} ( {y}_{p} - {y}_{b} ) - r ( {x}_{p} - {x}_{b} ) \\ \sqrt{- {r}^{2} + {( {x}_{p} - {x}_{b} )}^{2} + {( {y}_{p} - {y}_{b} )}^{2}}\end{matrix}}{{( {x}_{p} - {x}_{b} )}^{2} + {( {y}_{p} - {y}_{b} )}^{2}}$$

$${b}_{2} ( p , b , r ) = - {x}_{p} - {y}_{b} - \frac{\begin{matrix}{r}^{2} ( {y}_{p} - {y}_{b} ) - r ( {x}_{p} - {x}_{b} ) \\ \sqrt{- {r}^{2} + {( {x}_{p} - {x}_{b} )}^{2} + {( {y}_{p} - {y}_{b} )}^{2}}\end{matrix}}{{( {x}_{p} - {x}_{b} )}^{2} + {( {y}_{p} - {y}_{b} )}^{2}}$$

$${c}_{1} ( p , b , r ) = - {x}_{p} ( {x}_{b} - \frac{\begin{matrix}{r}^{2} ( {x}_{p} - {x}_{b} ) - r ( {y}_{p} - {y}_{b} ) \\ \sqrt{- {r}^{2} + {( {x}_{p} - {x}_{b} )}^{2} + {( {y}_{p} - {y}_{b} )}^{2}}\end{matrix}}{{( {x}_{p} - {x}_{b} )}^{2} + {( {y}_{p} - {y}_{b} )}^{2}} ) + {y}_{p} ( - {y}_{b} - \frac{\begin{matrix}{r}^{2} ( {y}_{p} - {y}_{b} ) - r ( {x}_{p} - {x}_{b} ) \\ \sqrt{- {r}^{2} + {( {x}_{p} - {x}_{b} )}^{2} + {( {y}_{p} - {y}_{b} )}^{2}}\end{matrix}}{{( {x}_{p} - {x}_{b} )}^{2} + {( {y}_{p} - {y}_{b} )}^{2}} )$$

$${c}_{2} ( p , b , r ) = - {x}_{p} ( {x}_{b} - \frac{\begin{matrix}{r}^{2} ( {x}_{p} - {x}_{b} ) - r ( {y}_{p} - {y}_{b} ) \\ \sqrt{- {r}^{2} + {( {x}_{p} - {x}_{b} )}^{2} + {( {y}_{p} - {y}_{b} )}^{2}}\end{matrix}}{{( {x}_{p} - {x}_{b} )}^{2} + {( {y}_{p} - {y}_{b} )}^{2}} ) + {y}_{p} ( - {y}_{b} - \frac{\begin{matrix}{r}^{2} ( {y}_{p} - {y}_{b} ) - r ( {x}_{p} - {x}_{b} ) \\ \sqrt{- {r}^{2} + {( {x}_{p} - {x}_{b} )}^{2} + {( {y}_{p} - {y}_{b} )}^{2}}\end{matrix}}{{( {x}_{p} - {x}_{b} )}^{2} + {( {y}_{p} - {y}_{b} )}^{2}} )$$

A similar expression for constraint 3 follows:

$$a ( p , b , r ) = {x}_{b} - {x}_{p}$$

$$b ( p , b , r ) = {y}_{b} - {y}_{p}$$

$$c ( p , b , r ) = {x}_{{t}_{i}} ( {x}_{b} - {x}_{p} ) - {y}_{{t}_{i}} ( {y}_{p} - {y}_{b} )$$

$${a}_{3} ( p , b , r ) = {x}_{b} - {x}_{p}$$

$${b}_{3} ( p , b , r ) = {y}_{b} - {y}_{p}$$

$${c}_{3} ( p , b , r ) = ( {x}_{b} - {x}_{p} ) ( {x}_{b} - \frac{r ( {x}_{b} - {x}_{p} ) \sqrt{{( {x}_{p} - {x}_{b} )}^{2} + {( {y}_{p} - {y}_{b} )}^{2}}}{{( {x}_{p} - {x}_{b} )}^{2} + {( {y}_{p} - {y}_{h} )}^{2}} ) - ( {y}_{p} - {y}_{b} ) ( {y}_{b} - \frac{r ( {y}_{b} - {y}_{p} ) \sqrt{{( {x}_{p} - {x}_{b} )}^{2} + {( {y}_{p} - {y}_{b} )}^{2}}}{{( {x}_{p} - {x}_{b} )}^{2} + {( {y}_{p} - {y}_{h} )}^{2}} )$$

There are two copies of each constraint aᵢx+bᵢy=cᵢ in the formulation, as each stopover point acts as both a start point and an end point for the points immediately before and after it on the route. In the formulation, stopover points are referred to as 0 and n+1; these are not actual stopover points, but are the start and end point, which have constant location. This shorthand is used to make the formulation slightly shorter.

The formulation requires a few additional changes from the original. First, the objective function is no longer the distance from start point to stopover point to end point, but rather the sum of all the distances between pairs along the path. The start point is referred to as (xₛ, yₛ), the end point as (xₑ, yₑ), and stopover points as (xₚᵢ, yₚᵢ) ∀i={1 . . . N}. The shorthand d((xₛ, yₛ), (xₚ, yₚ)) is also used to represent the distance between the points (xₛ, yₛ) and (xₚ, yₚ).

$$min d ( ( {x}_{p 1} , {y}_{p 1} ) , ( {x}_{e} - {y}_{e} ) ) + {\sum }_{i = 1}^{k - 1} d ( ( {x}_{pi + 1} , {y}_{pi + 1} ) , ( {x}_{pi} , {y}_{pi} ) ) + d ( ( {x}_{e} , {y}_{e} ) , ( {x}_{pn} , {y}_{pn} ) )$$

The final change is a constraint to control the distance between placed stopover points on the same route. Though a maximum amount of stopover points is set to n, fewer stopover points are allowed. To do this, the distance between any two stopover points is constrained to be either greater than their pad width pw, or equal to 0. A distance of 0 between any two points indicates that they are the same point and requires fewer than n stopover points.

All constraints related to restricted wire regions and components remain the same; these do not depend on stopover point locations. The formulation is shown below, but the substitutions of the tangent points in the interest of space is not made.

$$min d ( ( {x}_{p 1} , {y}_{p 1} ) , ( {x}_{e} - {y}_{e} ) ) + {\sum }_{i = 1}^{k - 1} d ( ( {x}_{pi + 1} , {y}_{pi + 1} ) ) + d ( ( {x}_{e} , {y}_{e} ) , ( {x}_{pn} , {y}_{pn} ) ) \\ s . t . {a}_{1} ( {p}_{i + 1} , b , r ) {x}_{pi} + {b}_{1} ( {p}_{i + 1} , b , r ) {y}_{pi} - {c}_{1} ( {p}_{i + 1} , b , r ) \leq ( 1 - {z}_{b 1} ) M \\ {a}_{2} ( {p}_{i + 1} , b , r ) {x}_{pi} + {b}_{2} ( {p}_{i + 1} , b , r ) {y}_{pi} - {c}_{2} ( {p}_{i + 1} , b , r ) \leq ( 1 - {z}_{b 2} ) M ∀ i ∈ \{ 0 … n \} , b ∈ B \\ {a}_{3} ( {p}_{i + 1} , b , r ) {x}_{pi} + {b}_{3} ( {p}_{i + 1} , b , r ) {y}_{pi} - {c}_{3} ( {p}_{i + 1} , b , r ) \leq ( 1 - {z}_{b 3} ) M \\ {z}_{b 1} + {z}_{b 2} + {z}_{b3} \geq 1 \\ {a}_{1} ( {p}_{i - 1} , b , r ) {x}_{pi} + {b}_{1} ( {p}_{i - 1} , b , r ) {y}_{pi} - {c}_{1} ( {p}_{i - 1} , b , r ) \leq ( 1 - {z}_{b 4} ) M \\ {a}_{2} ( {p}_{i - 1} , b , r ) {x}_{pi} + {b}_{2} ( {p}_{i - 1} , b , r ) {y}_{pi} - {c}_{2} ( {p}_{i - 1} , b , r ) \leq ( 1 - {z}_{b 5} ) M \\ ∀ i ∈ \{ 0 … n \} , b ∈ B \\ {a}_{3} ( {p}_{i - 1} , b , r ) {x}_{pi} + {b}_{3} ( {p}_{i - 1} , b , r ) {y}_{pi} - {c}_{3} ( {p}_{i - 1} , b , r ) \leq ( 1 - {z}_{b 6} ) M \\ {z}_{b 4} + {z}_{b 5} + {z}_{b 6} \geq 1 \\ {a}_{w 1} {x}_{p} + {b}_{w 1} {y}_{p} - {c}_{w 1} \leq ( 1 - {z}_{w 1} ) M \\ {a}_{w 2} {x}_{p} + {b}_{w 2} {y}_{p} - {c}_{w 2} \leq ( 1 - {z}_{w 2} ) M \\ {a}_{w 3} {x}_{p} + {b}_{w 3} {y}_{p} - {c}_{w 3} \leq ( 1 - {z}_{w 3} ) M ∀ w ∈ W \\ {a}_{w 4} {x}_{p} + {b}_{w 4} {y}_{p} - {c}_{w 4} \leq ( 1 - {z}_{w 4} ) M \\ {z}_{w 1} + {z}_{w 2} + {z}_{w 3} + {z}_{w 4} \geq 1 \\ {a}_{r 1} {x}_{p} + {b}_{r 1} {y}_{p} - {c}_{r 1} \leq ( 1 - {z}_{r1} ) M \\ {a}_{r 2} {x}_{p} + {b}_{r 2} {y}_{p} - {c}_{r2} \leq ( 1 - {z}_{r 2} ) M \\ {a}_{r 3} {x}_{p} + {b}_{r 3} {y}_{p} - {c}_{r 3} \leq ( 1 - {z}_{r 3} ) M ∀ w ∈ R \\ {a}_{r 4} {x}_{p} + {b}_{r 4} {y}_{p} - {c}_{r 4} \leq ( 1 - {z}_{r 2} ) M \\ {z}_{r 1} + {z}_{r 2} + {z}_{r 3} + {z}_{r 4} \geq 1 \\ d ( ( {x}_{pi} , {y}_{pi} ) , ( {x}_{pj} , {y}_{pj} ) ) \geq {p}_{w} or \\ d ( ( {x}_{pi} , {y}_{pi} ) , ( {x}_{pj} , {y}_{pj} ) ) = 0 ∀ i , j ∈ \{ 0 … n + 1 \} \\ {min}_{x} \leq {x}_{p} \leq {max}_{x} \\ {min}_{y} \leq {y}_{p} \leq {max}_{y} \\ {z}_{bi} , {z}_{wj} , {z}_{rk} ∈ \{ 0 , 1 \} ∀ b ∈ B , w ∈ W , {r ∈}^{71} R , i ∈ \{ 1 …6 \} , \\ j , k ∈ \{ 1 , 4 \} \qquad ( 51 )$$

### 2 Alternatives and Implementations

While the approaches described above use mixed-integer programming techniques as part of a process for determining a wire routing, other techniques can be used for determining the wire routing. For example, simulated annealing techniques and/or local routing techniques (as is described in the incorporated provisional application).

In the above description, a printed circuit board (PCB) is provided as an example of an interconnect that is replaced by the wire-only connection approach. But it should be noted that approaches described herein are not limited to PCBs—it should be understood that the approaches can be used for any multi-chip module system packaging configuration.

The techniques and all of the functional operations described in this specification can be implemented in digital electronic circuitry, or in computer hardware, firmware, software, or in combinations of them. The system can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the system can be performed by one or more programmable processors executing a computer program to perform functions of the system by operating on input data and generating output. Method steps can also be performed by, and apparatus of the system can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by or incorporated in special purpose logic circuitry.

To provide for interaction with a user, the system can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. Interaction with a user does not need to be direct. The system can be implemented with an application programming interface allowing alternative means of exchanging input data and output data with the system.

It is to be understood that the foregoing description is intended to illustrate and not to limit the scope of the invention, which is defined by the scope of the appended claims. Other embodiments are within the scope of the following claims.

What is claimed is:

1. A method for determining a wire connection plan, the method including:
receiving a wiring specification including a set of links and a first set of connection points, each link of the set of links specifying a connection between two connection points of the first set of connection points; and
determining the wire connection plan including an ordered sequence of wire segments linking points of a second set of connection points, the second set of connection points including the first set of connection points and a set of additional connection points,
at least some wire segments in the ordered sequence of wire segments linking two connection points of the first set of connection points,
at least some wire segments in the ordered sequence of wire segments forming part of a connection between two points in the first set of connection points through one or more of the connection points in the set of additional connection points, and
determining an order for the ordered sequence of wire segments such that each wire segment linking connection points of the second set of connection points does not cause occlusion of any connection point used in a later wire segment in the ordered sequence of wire segments.

2. The method of claim 1 further comprising forming a conflict graph from the wiring specification and determining the set of additional connection points based at least in part on the conflict graph.

3. The method of claim 2 wherein determining the set of additional connection points includes identifying the presence of a cycle in the conflict graph.

4. The method of claim 2 wherein identifying the presence of a cycle in the conflict graph includes determining that there is no ordered sequence of wire segments that connects the wire segments to the connection points of the first set of connection points without occluding at least one connection point of the first set of connection point.

5. The method of claim 2 wherein determining the set of additional connection points includes identifying candidate spatial locations for the set of additional connection points.

6. The method of claim 5 wherein identifying candidate locations for the set of additional connection points is based on a mixed-integer program approach.

7. The method of claim 6 wherein identifying the candidate locations includes applying spatial constraints to the wiring specification based on one or more of locations and dimensions of connection points, locations and dimensions of electrical components, and locations and dimensions of connected wires.

8. The method of claim 1 wherein determining the order for the ordered sequence of wire segments includes performing a topological sort.

9. The method of claim 1 wherein the wire segments include coaxial wires.

10. The method of claim 9 wherein a first subset of the wire segments is configured for routing power.

11. The method of claim 10 further comprising identifying, in the wiring specification, one or more capacitors specified as being connected to wire segments for routing power and modifying the wiring specification to extend a connection region associated with the identified one or more capacitors.

12. The method of claim 10 wherein a second subset of the wire segments is configured for carrying signals.

13. A system for determining a wire connection plan includes:
an input for receiving a wiring specification including a set of links and a first set of connection points, each link of the set of links specifying a connection between two connection points of the first set of connection points; and
one or more processing elements configured to perform the steps of:
determining the wire connection plan including an ordered sequence of wire segments linking points of a second set of connection points, the second set of connection points including the first set of connection points and a set of additional connection points,
at least some wire segments in the ordered sequence of wire segments linking two connection points of the first set of connection points,
at least some wire segments in the ordered sequence of wire segments forming part of a connection between two points in the first set of connection points through one or more of the connection points in the set of additional connection points, and
determining an order for the ordered sequence of wire segments such that each wire segment linking connection points of the second set of connection points does not cause occlusion of any connection point used in a later wire segment in the ordered sequence of wire segments.

14. Software embodied on a non-transitory machine-readable medium for determining a wire connection plan, the software including instructions for causing a computing system to:
receive a wiring specification including a set of links and a first set of connection points, each link of the set of links specifying a connection between two connection points of the first set of connection points; and
determine the wire connection plan including an ordered sequence of wire segments linking points of a second set of connection points, the second set of connection points including the first set of connection points and a set of additional connection points,
at least some wire segments in the ordered sequence of wire segments linking two connection points of the first set of connection points,
at least some wire segments in the ordered sequence of wire segments forming part of a connection between two points in the first set of connection points through one or more of the connection points in the set of additional connection points, and
determining an order for the ordered sequence of wire segments such that each wire segment linking connection points of the second set of connection points does not cause occlusion of any connection point used in a later wire segment in the ordered sequence of wire segments.

15. A system for determining a wire connection plan includes:
means for receiving a wiring specification including a set of links and a first set of connection points, each link of the set of links specifying a connection between two connection points of the first set of connection points; and
means for performing the steps of:
determining the wire connection plan including an ordered sequence of wire segments linking points of a second set of connection points, the second set of connection points including the first set of connection points and a set of additional connection points,
at least some wire segments in the ordered sequence of wire segments linking two connection points of the first set of connection points,
at least some wire segments in the ordered sequence of wire segments forming part of a connection between two points in the first set of connection points through one or more of the connection points in the set of additional connection points, and
determining an order for the ordered sequence of wire segments such that each wire segment linking connection points of the second set of connection points does not cause occlusion of any connection point used in a later wire segment in the ordered sequence of wire segments.
